(19) United States
(12) Patent Application Publication
(10) Pub. No.: US 2021/0293366 A1
(43) Pub. Date: Sep. 23, 2021

(54) CAP WITH LOCK RING TO SEAL SERVICE PORT WITH SPRING BIASED VALVE

(71) Applicant: Airsept, Inc., Atlanta, GA (US)

(72) Inventor: Aaron Becker, Atlanta, GA (US)

(21) Appl. No.: 17/303,774

(22) Filed: Jun. 7, 2021

Related U.S. Application Data
(63) Continuation-in-part of application No. 14/026,420, filed on Sep. 13, 2013, now Pat. No. 11,027,591.
(60) Provisional application No. 61/700,522, filed on Sep. 13, 2012.
(60) Provisional application No. 61/770,576, filed on Feb. 28, 2013.

(51) Int. Cl. F16L 55/115; F16K 15/02

(52) U.S. Cl. CPC F16L 55/1157; F25B 45/00; F16K 15/025

(57) ABSTRACT

A service port cap fits over the nipple (free end), annular flange and groove of a service port. An annular concavity (groove) in the interior wall of the cap receives the outwardly projecting annular flange of the service port. A resilient gasket disposed in the interior top of the cap is configured to plug the free end of the service port, when the cap is installed. Slots in the cap body define legs that can deflect outwardly and then return to an undeflected position when a deflecting force is removed. A locking ring, which includes an annular band that surrounds a portion of the cap body, is movable longitudinally between an unlocked position and a locked position in which the band surrounds and prevents outward deflection of the legs.

### RELATED APPLICATIONS

This application is a continuation in part and the claims the benefit of priority of U.S. Nonprovisional application Ser. No. 14/026,420, filed on Sep. 13, 2013, which is a nonprovisional of and claims the benefit of priority of U.S. Provisional Application 61/700,522 filed on Sep. 13, 2012 and U.S. Provisional Application 61/770,576 filed on Feb. 28, 2013, all of which are hereby incorporated by reference as if fully set forth herein.

### FIELD OF THE INVENTION

This invention relates generally to service ports, i.e., ports that contain a spring-biased valve for controlling the flow of a pressurized fluid through the port, and, more specifically, to a cap adapted to provide a seal on such a port and a service port sealed with such a cap, wherein the cap includes a gasket, resilient sections defined between axial slots that clamp and release an exterior annular flange on the port, and a locking ring that moves axially from a locked position, constraining spreading of the resilient sections, to an unlocked position allowing spreading of the resilient sections.

### BACKGROUND OF THE INVENTION

Air conditioning systems and some refrigerant containers include a service port. A service port is a valve assembly that contains a valve core and includes a radially projecting exterior annular flange. By way of example and not limitation, a service port may include a hollow cylindrical metal tube with a free end and an attachment end. The exterior surface of the tube varies in outer diameter at points along its length, as described herein. The attachment end, which is opposite to the free end, is configured for attachment to a container, line (e.g., tubing), equipment port or some other product. By way of example, the attachment end may be internally or externally threaded or welded, brazed or otherwise coupled. The free end is typically internally threaded.

A valve core is contained in the metal tube of the service port. The valve core may have external threads that engage internal threads at the attachment end of the tube. The valve core is a pressure valve, such as a poppet valve assisted by a spring. The poppet valve includes a valve body that engages a valve seat, providing a fluid tight seal when the valve is closed. The seat may include an elastomeric seal. A valve stem extends towards the free end of the service port, but does not extend beyond the free end. Movement of the valve stem towards the attached end, away from the free end, causes the valve body to separate from the valve seat, thereby allowing fluid to pass through the poppet valve.

Automotive and other air conditioning systems include service ports that communicate with the refrigerant through the tubing or at other locations. Internal pressure valves normally seal off the ports during operation of the air conditioning system to prevent refrigerant from leaking through the service ports. Devices can be connected to these ports for a variety of purposes such as, for instance, checking the level of refrigerant in the system, evacuating the system in preparation for the introduction of new refrigerant, connecting diagnostic equipment, and introducing new refrigerant into the system. Most systems include at least a “low side” service port on the low pressure side of a compressor and a “high side” service port on the high pressure side of the compressor. These service ports typically have the same exterior profile with the high side port perhaps being of a larger diameter than the low side port.

Service ports are usually covered with caps that protect the ports from dirt, oil, and other contaminants. While the caps work well for this function, they can be problematic in the event of a refrigerant leak through the service port due to a failing internal pressure valve. The pressure of the leaking and perhaps evaporating refrigerant can blow a traditional cap off of the service port exposing the port to damage by dirt and debris. The blown off cap becomes a projectile that can lodge in unwanted locations or become a hazard. Further, the continuing leakage of the refrigerant can spew the refrigerant and oily lubricants therein onto other components in the engine compartment. Some service port caps have been designed with internal “pop off” valve structures that open before the pressure of the refrigerant within the cap is sufficient to blow off the cap itself. However, these pop off valves tend to direct escaping refrigerant away from the valve and toward other sensitive components within an engine compartment.

Refrigerant containers may be equipped with service ports. Such containers may be used to supply refrigerant to new or serviced air conditioning systems. A conventional cap may not withstand a leak, resulting in unintended premature evacuation of the contents of the container. Such leaked contents may pollute the environment and contaminate nearby objects such as tools, retail displays, packaging and the like.

Products and systems other than refrigerant systems and containers may contain a pressurized fluid and include a service port. Any such product or system that contains a pressurized fluid and includes a service port may have a similar need for a service port cap. The problems described herein are not limited to a particular system or product to which a service port is attached.

A need exists for a service port cap that will not be blown off by a pressurized fluid leak through the service port and that will not allow escaping fluid, such as refrigerant and lubricant, to be spewed uncontrolled into the atmosphere and surroundings (e.g., an engine compartment of a vehicle). Additionally, the service port cap should be easy to install and remove, and reliably maintain a seal when installed.

The invention is directed to overcoming one or more of the problems and solving one or more of the needs as set forth above.

### SUMMARY OF THE INVENTION

To solve one or more of the problems set forth above, in an exemplary implementation of the invention, a service port cap is disclosed for snapping onto a service port, such as, but not limited to, a service port of an air conditioning system, and particularly an automotive air conditioning system, to protect the service ports. The service port cap has an interior wall sized to fit over the nipple (free end) of a service port and an annular concavity (groove) in the interior wall sized and positioned to snap onto the outwardly projecting annular flange of the service port. A resilient gasket disposed in the interior top of the cap is configured to plug the free end of the service port, when the cap is installed. Slots in the cap body define legs that can deflect outwardly and then return to an undeflected position when an outward force is removed. A locking ring, which includes an annular band that surrounds a portion of the cap body, is movable longitudinally between a locked position and an unlocked position. In the locked position, the annular band surrounds a portion of the legs and limits (e.g., prevents) appreciable outward deflection of each leg from the undeflected position.

More specifically, a cap assembly is provided for sealing a service port. The service port is a hollow tubular port, with an external diameter that varies at points along its length. The port contains a valve core (e.g., a spring biased poppet valve) for controlling the flow of a pressurized fluid. The cap assembly includes a cap body, a locking ring, and a gasket. The cap body includes top, middle and bottom portions. The top portion provides a cover. The middle portion, which extends from the top portion, is a generally tubular portion defining a generally cylindrical interior space. The bottom portion, which extends from the middle portion, includes an interior annular concavity. The interior annular concavity includes a pitched (i.e., sloped, inclined) leading edge, a cylindrical central portion and a pitched trailing edge. The pitched leading edge extends from the middle portion to the cylindrical central portion. The pitched trailing edge extends to a free end.

The cap body includes a plurality of legs, each defined by a pair of longitudinal slots. A plurality of (at least 4, preferably at least 6) spaced (e.g., evenly spaced) apart longitudinal slots extend from the middle portion to the bottom portion. Adjacent slots define a leg therebetween. The plurality of spaced apart longitudinal slots define a plurality of legs. Each leg includes a free end with a beveled inner edge, which facilitates installation. Each leg is resilient, i.e., flexible, and, in particular, capable of outward deflection from an undeflected position when a deflecting force acts thereon and capable of returning to an undeflected position when the deflecting force is removed.

The locking ring, which includes an annular band that surrounds a portion of the cap body, is movable longitudinally between a locked position and an unlocked position. In the unlocked position the annular band surrounds a portion of the middle portion. In the unlocked position, the annular band does not resist outward deflection (spreading apart) of the legs. In the locked position, the annular band surrounds a portion of the bottom portion and limits (e.g., prevents) appreciable outward deflection of each leg from the undeflected position.

The gasket is a resilient seal disposed in and occupying a top section of the generally cylindrical interior space of the middle portion of the cap body. As used in reference to the gasket seal, resilient connotes elasticity and suppleness, such that when pressed (using normal manual force) between the free end of a service port and the inner side of the top of the cap body, the gasket will compress and receive and intimately abut the free end of the service port, and when the pressing ceases, such as when the cap body is removed from the service port, the gasket may resume its original shape. Although, over time, after repeated cycles of use, the gasket may cease to fully resume its original shape, without departing from the scope of the invention. The gasket abuts the top portion. The body of the gasket includes a generally cylindrical base, an annular outer periphery, a frustoconical projection extending from the base. The projection is concentric with the base and periphery. An annular furrow is defined between the annular outer periphery and the frustoconical projection. A depression (in the shape of a negative of a spherical cap) is formed in the free end of the frustoconical projection, concentric with the base and periphery.

The cap body may further include an exterior surface and at least one rib (e.g., two evenly spaced apart ribs), each of which has a rib width, extends outwardly from the exterior surface of the cap body, extends longitudinally from the top portion to the bottom portion. Each rib includes an upper segment, a lower segment and a notched segment between the upper segment and lower segment. The notched segment facilitates bending. In such an embodiment, the annular band includes an interior band surface and a slot in the interior band surface for each rib. Each slot has a slot width that is at least equal to the rib width.

The cap body may further includes a plurality of shims (i.e. spacers). Each shim is an outward protrusion located on one of the plurality of legs at the bottom portion of the cap body. Each shim occupies space between the annular band and the leg when the locking ring is in a locked position.

The cap body may have a varying wall thickness. For example, the wall thickness at the middle portion may be less than the wall thickness at the bottom portion, to facilitate bending of legs at the middle portion.

In one embodiment, the top portion defines a radially extending flange having a peripheral diameter. In other embodiments, the top portion is a closed end of the cap body.

Each of the cap body and locking ring may be integrally formed by injection molding a thermoplastic. However, the invention is not limited to such molding or materials.

In one embodiment, the locking ring includes a sleeve extending from the annular band. The sleeve increases the height of the portion of the locking ring that surrounds the cap body. Instead of that portion being a narrow ring it is a relatively wide ring that provides greater stability and locking power. The sleeve and annular band are concentric and have equal inner diameters. If the annular band is slotted, so too is the sleeve. In such an embodiment, each slot in the interior band surface for each rib extends as a continuum along the interior band surface of the annular band and along the interior sleeve surface of the sleeve. Optionally, the sleeve may include a peripheral protrusion extending inwardly from the interior surface of the sleeve. The peripheral protrusion abuts a shim when the locking ring is in a locked position.

The locking ring may also include a collar with a central aperture. In such an embodiment, a flexible tether may couple the annular band to the collar. The collar may surround a portion of a service port cap or an adjacent line, while the tethered annular band and sleeve surround a portion of the cap body.

In use, the cap body covers a substantial portion of a service port. The service port includes a hollow cylindrical metal tube with a free end, an attachment end opposite the free end, and a radially projecting exterior annular flange between the free end and the attachment end. The radially projecting exterior annular flange includes a beveled leading edge and a beveled trailing edge. The hollow cylindrical metal tube contains a valve core, which prevents flow of fluid through the hollow cylindrical metal tube when the valve core is in a closed position and permits flow of fluid through the hollow cylindrical metal tube when the valve core is in an opened position. The interior annular concavity of the cap body is configured to receive and abut the radially projecting exterior annular flange of the service port, including the beveled leading edge and the beveled trailing edge of the radially projecting exterior annular flange, when the cap body is installed on the service port, without causing the legs to spread apart (i.e., deflect outwardly).

The service port may also include an exterior annular groove between the trailing edge of the radially projecting exterior annular flange and the attachment end of the hollow cylindrical metal tube of the service port. The exterior annular groove is configured to receive and abut the free end of each leg of the plurality of legs, when the cap body is installed on the service port, without causing the plurality of legs to spread apart. The frustoconical projection of the gasket extends into and seals (plugs) the free end of the hollow cylindrical metal tube of the service port, when the cap body is installed on the service port.

### BRIEF DESCRIPTION OF THE DRAWINGS

The foregoing and other aspects, objects, features and advantages of the invention will become better understood with reference to the following description, appended claims, and accompanying drawings, where:

FIG. 1 is an exploded perspective view of an exemplary service port cap and service port according to principles of the invention.

FIG. 2 provides a bottom perspective view of an exemplary service port cap according to principles of the invention.

FIG. 3 provides a bottom view of an exemplary service port cap according to principles of the invention.

FIGS. 4-6 provide dimensioned side section views of an exemplary service port cap according to principles of the invention. All dimensions are provided as nonlimiting examples. Dimensions may be varied without departing from the scope of the invention. Dimensions in square brackets are in inches, other dimensions are in millimeters.

FIG. 7 provides a detail view of a free end portion of an exemplary leg of an exemplary service port cap according to principles of the invention. The scale is provided as a nonlimiting example. All dimensions are provided as nonlimiting examples. Dimensions may be varied without departing from the scope of the invention. Dimensions in square brackets are in inches, other dimensions are in millimeters.

FIG. 8 provides a perspective view of an exemplary locking ring for a service port cap according to principles of the invention.

FIGS. 9-10 provide dimensioned views of an exemplary locking ring for a service port cap according to principles of the invention. All dimensions are provided as nonlimiting examples. Dimensions may be varied without departing from the scope of the invention. Dimensions in square brackets are in inches, other dimensions are in millimeters.

FIG. 11 provides a section view of an exemplary locking ring for a service port cap according to principles of the invention.

FIG. 12 provides a bottom perspective view of an exemplary gasket for a service port cap according to principles of the invention.

FIG. 13 provides a bottom view of an exemplary gasket for a service port cap according to principles of the invention.

FIG. 14 provides a perspective section view of an exemplary gasket for a service port cap according to principles of the invention.

FIG. 15 provides a dimensioned section view of an exemplary gasket for a service port cap according to principles of the invention. All dimensions are provided as nonlimiting examples. Dimensions may be varied without departing from the scope of the invention. Dimensions in square brackets are in inches, other dimensions are in millimeters.

FIG. 16 provides a perspective view of an exemplary service port for a service port cap according to principles of the invention.

FIG. 17 provides a profile view of an exemplary service port cap installed on a service port according to principles of the invention.

FIG. 18 provides a plan view of an exemplary service port cap installed on a service port according to principles of the invention.

FIG. 19 provides a section view of an exemplary service port cap installed on a service port according to principles of the invention.

FIG. 20 provides a section detail view of an exemplary service port cap installed on a service port according to principles of the invention.

FIG. 21 provides a section view of an exemplary service port cap in a first position on a service port according to principles of the invention.

FIG. 22 provides a section view of an exemplary service port cap in a second position on a service port according to principles of the invention.

FIG. 23 provides a section view of an exemplary service port cap in a third position on a service port according to principles of the invention.

FIG. 24 provides a section view of an exemplary service port cap locked in the third position on a service port according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

Certain figures may include dimensions. All dimensions are provided as nonlimiting examples of an exemplary embodiment. Dimensions may be varied without departing from the scope of the invention. Dimensions in square brackets are in inches, other dimensions are in millimeters.

### DETAILED DESCRIPTION

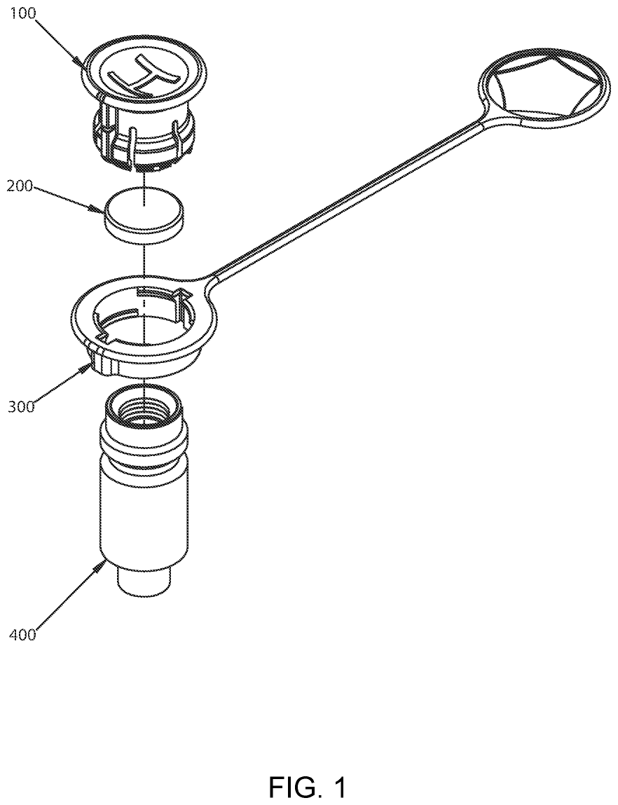

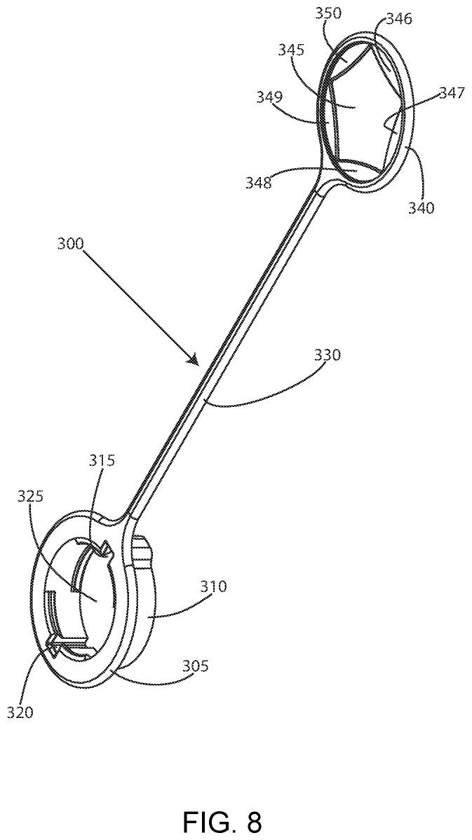

Referring to the figures, wherein like reference numerals, where appropriate, indicate like parts throughout the several views, FIG. 1 provides an exploded perspective view of an exemplary service port cap, including a cap body 100, gasket 200, locking ring 300, and service port 400, components, features and functions of which are described in more detail below. During use, the gasket 200 is contained within the cap body 100. The locking ring 300 includes an annular band that surrounds a portion of the cap body 100. The service port 400 is the port that contains a valve core for controlling flow of a pressurized fluid. The cap body 100, which contains the gasket 200, engages the open top end of the service port 400. The annular band 310 (FIG. 8) of the locking ring 300 surrounds a portion of the cap body 100 and is movable axially between locked and unlocked positions.

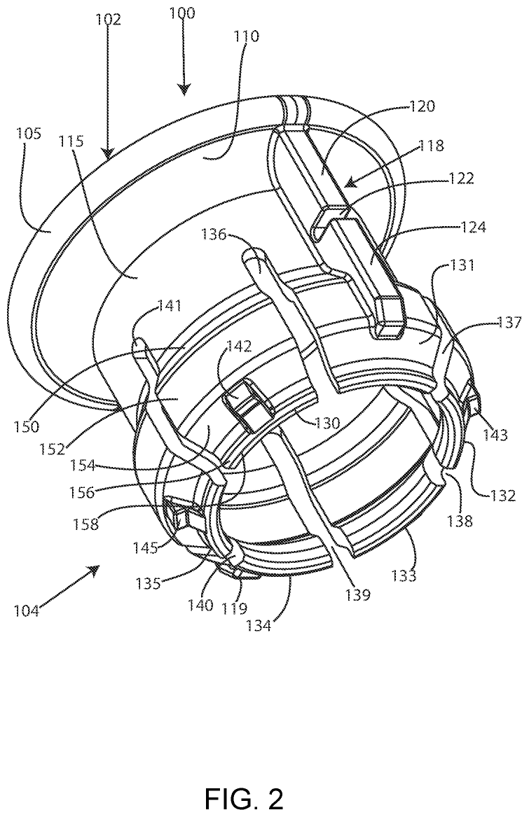

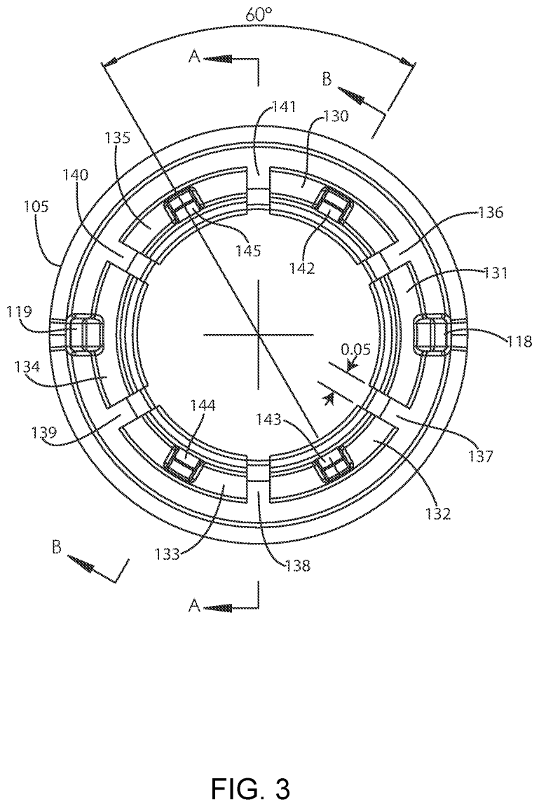

FIGS. 2 and 3 conceptually illustrate the cap body 100 in greater detail. The cap body 100 includes a top portion 102, a mid portion 115, and a bottom portion 104. A plurality of axial slits or slots 136-141 are formed in the cap body 100 and extend from the bottom portion 104 into the mid portion 115, as illustrated. Each pair of adjacent slots (i.e., slots 136 and 137, 137 and 138, 138 and 139, 139 and 140, 140 and 141, and 141 and 136) define separate sections, referred to herein as legs 130-135. The axial slots 136-141 allow the bottom portion 104 and part of the mid portion 115 of the cap body 100 to spread apart. More particularly, the slots 136-141 facilitate deflection of the legs 130-135. The legs 130-135 may be urged outwardly (i.e., away from a central axis of the cap body 100), thereby spreading apart and increasing the interior space.

In sum, a cap assembly is provided for sealing a service port. The service port is a hollow tubular port, with an external diameter that varies at points along its length. The port contains a valve core (e.g., a spring biased poppet valve) for controlling the flow of a pressurized fluid. The cap assembly includes a cap body, a locking ring, and a gasket. The cap body includes top, middle and bottom portions. The top portion provides a cover. The middle portion, which extends from the top portion, is a generally tubular portion defining a generally cylindrical interior space. The bottom portion, which extends from the middle portion, includes an interior annular concavity. The interior annular concavity includes a pitched leading edge, a cylindrical central portion and a pitched trailing edge. The pitched leading edge extends from the middle portion to the cylindrical central portion. The pitched trailing edge extends to a free end.

The cap body includes a plurality of legs, each defined by a pair of longitudinal slots. A plurality of (at least 4, preferably at least 6) spaced (e.g., evenly spaced) apart longitudinal slots extend from the middle portion to the bottom portion. Adjacent slots define a leg therebetween. The plurality of spaced apart longitudinal slots define a plurality of legs. Each leg includes a free end with a beveled inner edge, which facilitates installation. Each leg is resilient, i.e., flexible, and, in particular, capable of outward deflection from an undeflected position when a deflecting force acts thereon and capable of returning to an undeflected position when the deflecting force is removed.

In one embodiment, the legs 130-135 are resilient. When an outwardly urging force is removed, the legs 130-135 return to their un-deflected position. Caps with resilient legs may be comprised of resilient metals, composites or plastics, with sufficient toughness to endure many cycles of use (i.e., installation and removal) without failure.

In another embodiment, the legs 130-135 are malleable. When an outwardly urging force is removed, the legs 130-135 do not return to their undeflected position until urged inwardly. Caps with malleable legs may be comprised of malleable metals or plastics, with sufficient toughness to endure many cycles of use (i.e., cycles of installation and removal) without failure.

An annular concavity 151 is formed around the interior of the cap body 100 adjacent its bottom portion. A corresponding outer annular bulge 152 accommodates the annular concavity 151 and maintains a similar wall thickness of the cap body 100 across the annular concavity 151. A pitched portion, the mid transition 150, provides a transition from the mid portion 115 to the annular bulge 152. Another pitched portion, the bottom transition 154, leads from the annular bulge 152 to the bottom edge 156 and free end 158. The transitions 150, 154 may be generally planar or curved. The inner and outer diameters of the mid portion 115 are respectively less than the inner and outer diameters of the annular bulge 152. Likewise, the inner and outer diameters of the bottom edge 156 are respectively less than the inner and outer diameters of the annular bulge 152. Additionally, in one embodiment, the inner and outer diameters of the bottom edge 156 are respectively less than the inner and outer diameters of the mid portion 115.

A spacer or shim 142-145 is provided on some (or all) of the legs 130, 132, 133 and 135. The shims 142-145, which are located at the bottom 104, e.g., at the bottom transition 154, of each such leg 130, 132, 133 and 135, are small outward protrusions, narrower than the leg width. The shims 142-145, occupy space between the bottom transition 154 and the annular band 305 of the locking ring 300, when the annular band 305 is in a locked position. By so occupying the space, the shims 142-145 help resist outward deflection of the legs 130, 132, 133 and 135. Such resistance helps prevent unintended dislodging of the cap body 100 from a service port.

In sum, the cap body may further includes a plurality of shims (i.e. spacers). Each shim is an outward protrusion located on one of the plurality of legs at the bottom portion of the cap body. Each shim occupies space between the annular band and the leg when the locking ring is in a locked position.

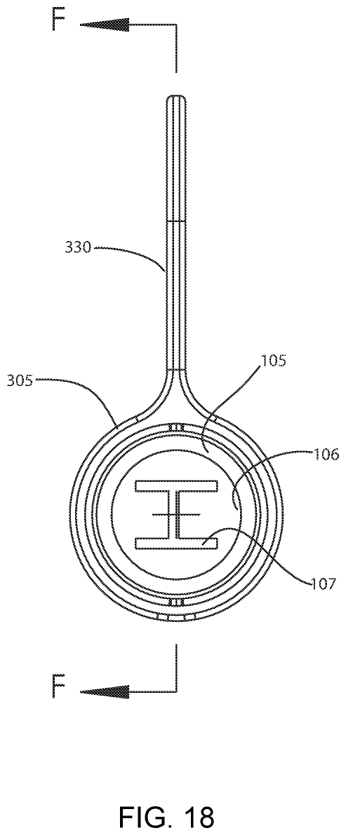

In the exemplary embodiment, the top portion 102 includes a radially-extending concave, disc-shaped terminus (cover) 105 with a shoulder or exposed underside 110, as illustrated. As evident in FIG. 18, the upper surface 106 of the cover 105 may include an indicium (e.g., a marking such as a boss [i.e., protruding] letter H 107) to indicate the purpose of the cap. In the exemplary embodiment, the boss H 107 may signify that the cap is configured to fit a high-pressure side service port. Such indicium also assists a service provider in correctly identifying a port for service. A boss indicium covered in grease and grime is easy to expose with a rag and cleanser or degreaser, without compromising the legibility of the indicium.

In the exemplary embodiment, a pair of ribs 118, 119 are provided. Each rib 118, 119 projects outwardly. Each rib 118, 119 extends from the shoulder 110 to the bottom transition 154. In this embodiment, legs 131, 134 which include ribs 118, 119, do not also include shims. The bottom end of the rib 118, 119 obviates the shim. Each rib 118, 119 extends axially, aligned with the central axis of the leg 131, 134 (i.e., the longitudinal axis that divides the leg into symmetric halves). In the exemplary embodiment, rib 118 is opposite rib 119.

Each rib includes an upper portion 120, a lower portion 124 and a notched portion 122 between the upper 120 and lower 124 portions. The notched portion facilitates bending (e.g., bending for outward deflection) of the leg 131, 134, adjacent to the top of the corresponding slots 136, 137 and 139, 140, that define the legs 131, 134.

The exemplary ribs 118, 119 have a generally rectangular cross section shape. However, the invention is not limited to such a shape. Other shapes, such as, but not limited to, semicircular cross-section shapes, may be used without departing from the scope of the invention in embodiments that include ribs.

Each rib 118, 119 extends (projects outwardly) radially to a determined radial distance (except at the notched portion 122). The radial distance allows each rib 118, 119, to engage or mate with the slits 315, 320 (FIG. 8) in the annular band 305. The slits 315, 320 are configured (i.e., sized, shaped and positioned) to allow sliding linear motion of the annular band 305, between locked and unlocked positions, with the ribs 118, 119 at least partially received in the slits 315, 320. The ribs 118, 119 engaging the slits 315, 320 prevent rotation of the annular band 300 relative to the cap body 100.

In sum, The cap body may further include an exterior surface and at least one rib (e.g., two evenly spaced apart ribs), each of which has a rib width, extends outwardly from the exterior surface of the cap body, extends longitudinally from the top portion to the bottom portion. Each rib includes an upper segment, a lower segment and a notched segment between the upper segment and lower segment. The notched segment facilitates bending. In such an embodiment, the annular band includes an interior band surface and a slot in the interior band surface for each rib. Each slot has a slot width that is at least equal to the rib width.

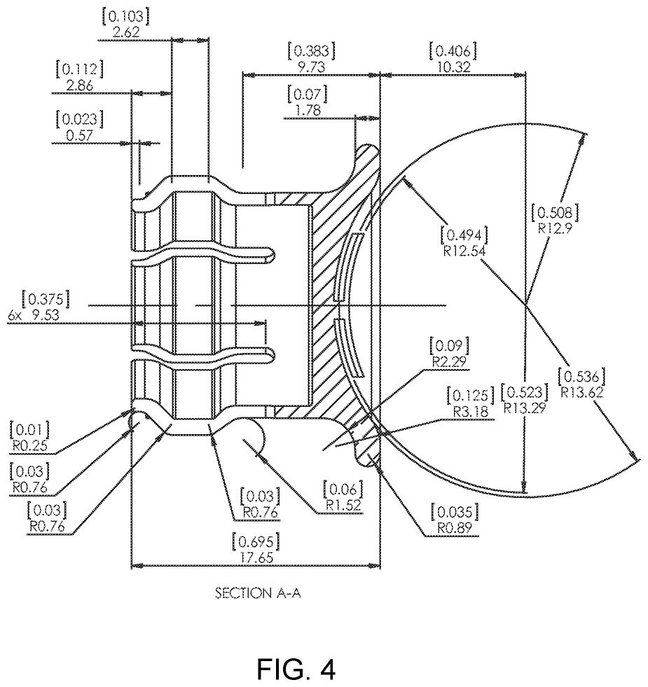

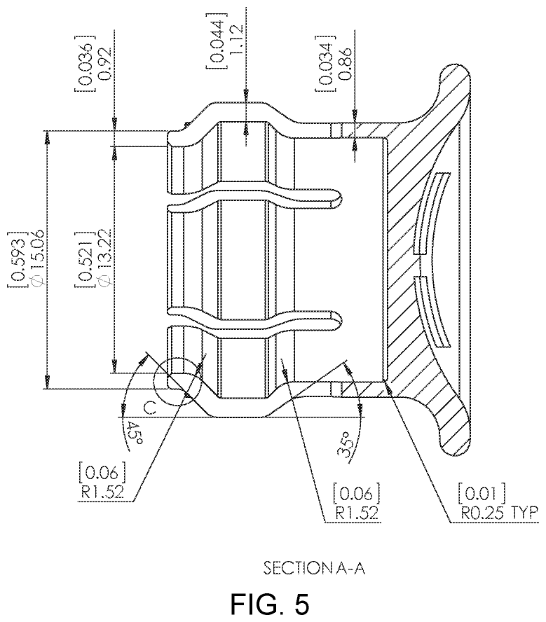

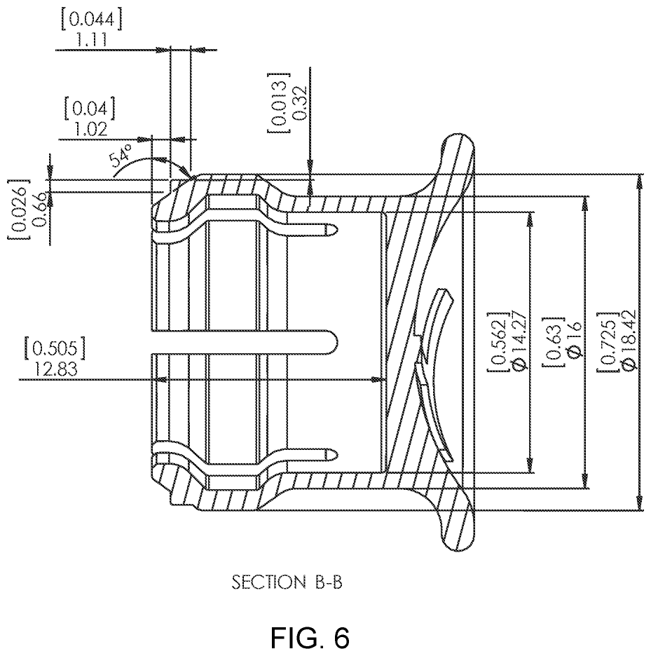

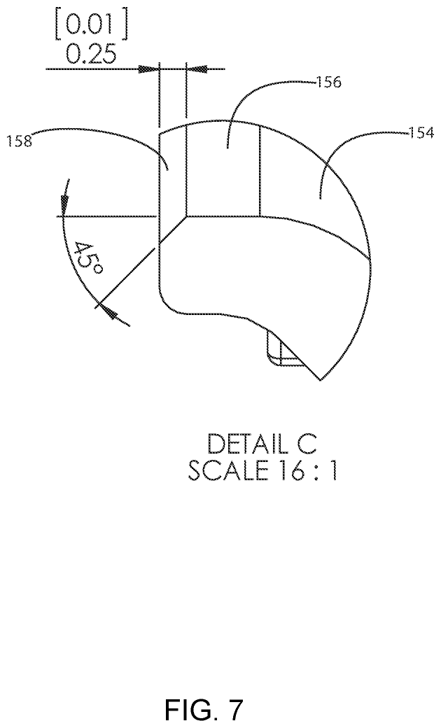

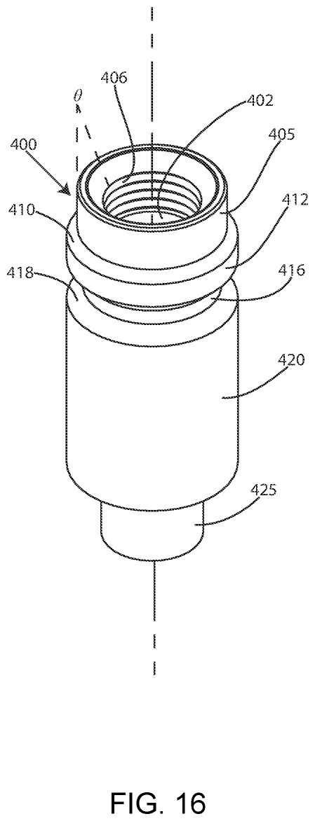

FIGS. 4-6 provide exemplary (nonlimiting) dimensions for sections A-A and B-B of the cap body 100, as noted in FIG. 3. FIG. 7 provides a detail view of region C as noted in FIG. 5. In the exemplary embodiment, the wall thickness is less at the middle portion 115 than at the bottom portion 104. This configuration facilitates bending of the legs 130-135 at about the top of the slots 136-141. The inner diameter at the free ends of the legs 130-135, as shown in the undeflected configuration of FIG. 5, increases to about the inner diameter at the annular concavity 151 when the legs 130-135 are deflected outwardly to allow the free ends of the legs 130-135 to pass over the radially projecting exterior annular flange of the service port during installation and removal of the cap. As shown in FIGS. 5 and 6, the inner diameter of the middle portion 115 is about (equal or slightly larger than) the outer diameter of a nipple 405 (FIG. 16) of service port; and the inner diameter of the annular concavity 151, when the legs 130-135 are undeflected, is about (equal or slightly larger than) the outer diameter of the radially projecting exterior annular flange of the service port; and the inner diameter of the bottom portion 104, when the legs 130-135 are undeflected, is about (equal or slightly larger than) the outer diameter of the waist of the service port.

In sum, the cap body may have a varying wall thickness. For example, the wall thickness at the middle portion may be less than the wall thickness at the bottom portion, to facilitate bending of legs at the middle portion.

The inner free edge 158 of each leg is a fillet or bevel (a bevel as shown in the detail view of FIG. 7) to facilitate sliding onto a service port. The cap body 100 is installed by forcing the cap body 100 onto a service port. During installation, as the beveled edge 158 encounters an outwardly extending feature of the service port, such as a radially projecting exterior annular flange, the configuration of the edge (beveled or filleted) directs some of the downward force to urge the legs 130-135 apart, thus accommodating the outwardly extending feature of the service port.

A generally planar portion 156 and a pitched or curved portion 154 follow the beveled edge 158. The pitched or curved portion 154 provides an interior transition from the planar portion 156 to the annular concavity 151.

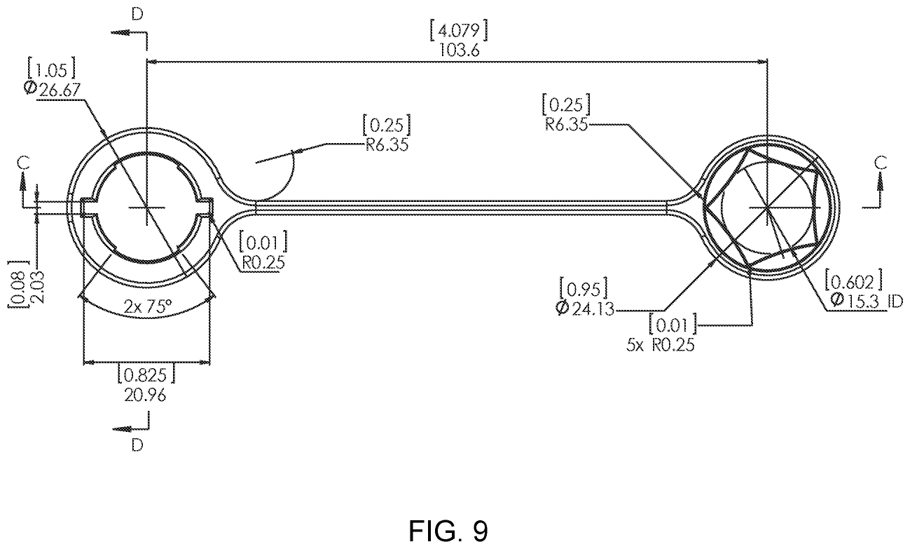

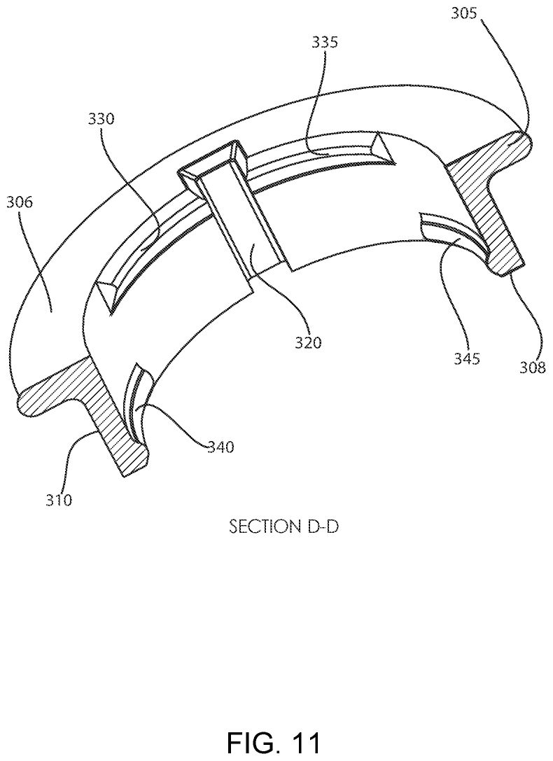

Referring now to FIGS. 8-11, an exemplary locking ring 300 and portions thereof are conceptually illustrated. The exemplary locking ring 300 includes an annular band 305, a tether 330 and a collar 340. The annular band 305 includes a sleeve 310, a pair of slots 315, 320, and a central passage 325. The annular band 305 and sleeve 310 are concentric and have the same inner diameter. The sleeve 310 extends from the annular band 305. The annular band 305 and sleeve 310 are symmetric about the cutting plane E-E (FIG. 9). Interior ribs or wedges 330, 335, 340, 345, as illustrated in section E-E in FIG. 11, are provided to engage (e.g., abut) surfaces of the cap body 100. Specifically, ribs 330 and 335 engage the outer annular bulge 152 while ribs 340, 345 engage the shims 142-145. The slots 315, 320 extend through the annular band 305 and sleeve 310.

In sum, The locking ring, which includes an annular band that surrounds a portion of the cap body, is movable longitudinally between a locked position and an unlocked position. In the unlocked position the annular band surrounds a portion of the middle portion. In the unlocked position, the annular band does not resist outward deflection (spreading apart) of the legs. In the locked position, the annular band surrounds a portion of the bottom portion and limits (e.g., prevents) appreciable outward deflection of each leg from the undeflected position.

In one embodiment, the locking ring includes a sleeve extending from the annular band. The sleeve increases the height of the portion of the locking ring that surrounds the cap body. Instead of that portion being a narrow ring it is a relatively wide band that provides greater stability and locking power. The sleeve and annular band are concentric and have equal inner diameters. If the annular band is slotted, so too is the sleeve. In such an embodiment, each slot in the interior band surface for each rib extends as a continuum along the interior band surface of the annular band and along the interior sleeve surface of the sleeve. Optionally, the sleeve may include a peripheral protrusion extending inwardly from the interior surface of the sleeve. The peripheral protrusion abuts a shim when the locking ring is in a locked position.

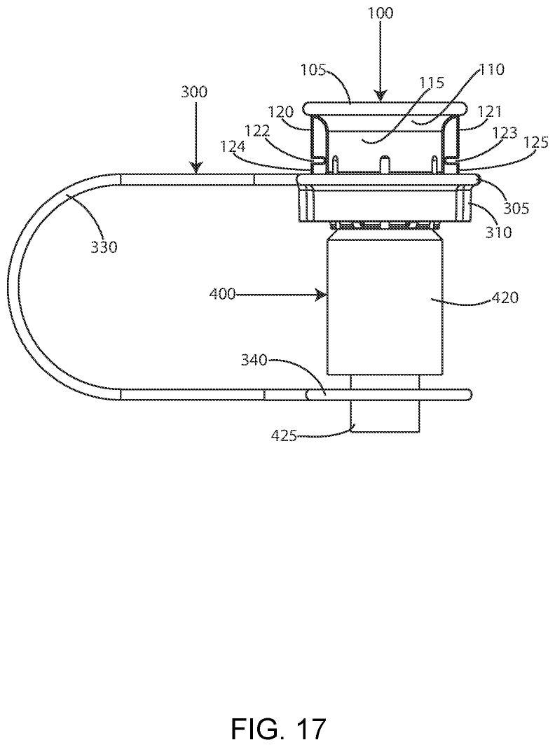

The collar 340 is configured (sized and shaped) to surround a portion of a service port that is below the portion covered by the cap body 100 when the cap is installed. By way of example and not limitation, in FIG. 17, the collar surrounds the bottom-most portion of the service port. The exemplary collar 340 includes an annular outer rim 340 and a plurality of evenly spaced apart circular segments (i.e., scallops) 346-350 on the interior edge of the rim 340. The scallops 346-350 define a pentagonal opening 345. The opening 345 is sized to receive a portion of a service port.

The tether 330 is a slender strap that extends between and connects the annular band 305 and the collar 340. The tether 330 is flexible. The tether may be bent into various shapes, including a U-shape as illustrated in FIGS. 17-19. Thus, in use, the collar 340 surrounds a portion of the service port, and the tether 330 extends from the collar 340 to the annular band 305. Concomitantly, the annular band 305 surrounds a portion of the cap body 100.

In use, when the cap body 100 is installed on a service port, the tether may bend into a U-shape. When the cap body 100 is removed from a service port, the tether 330 restrains the annular band 305 and cap body 100 from falling and being misplaced. Of course, the collar 340 may be removed from a service port, such as for the purpose of replacing the cap assembly. However, so long as the collar 340 engages a portion of the service port, and the annular band 305 surrounds a portion of the cap body 100, the cap body 100 is protected from loss, such as by falling into a crowded engine compartment or being misplaced.

In sum, the locking ring may also include a collar with a central aperture. In such an embodiment, a flexible tether may couple the annular band to the collar. The collar may surround a portion of a service port cap or an adjacent line, while the tethered annular band and sleeve surround a portion of the cap body.

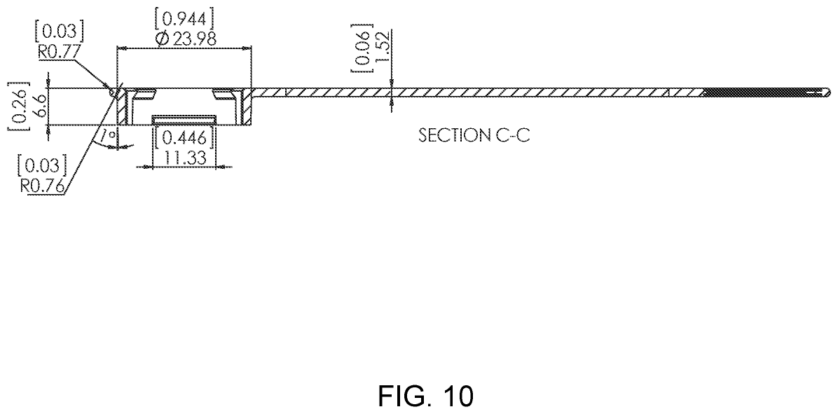

FIGS. 9 and 10 provide dimensioned views of an exemplary locking ring 300 according to principles of the invention. The dimensions are provided as nonlimiting examples and may be varied without departing from the scope of the invention. Dimensions in square brackets are in inches, other dimensions are in millimeters. Of note, the diameter of the circular opening 325 in the annular band 305, at a portion that excludes ribs and slots, is about 17.78 mm. Also of note, the pentagonal opening 345 in the collar 340 accommodates a circle with a diameter up to about 15.3 mm, without encroaching on the scallops 346-350. A service port section having a larger diameter may be accommodated by deforming the scallops 346-350, or by providing a collar with a larger opening.

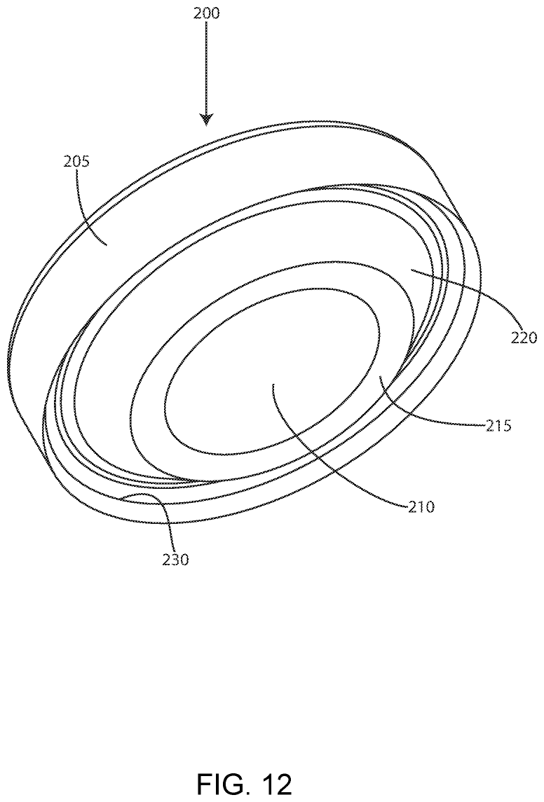

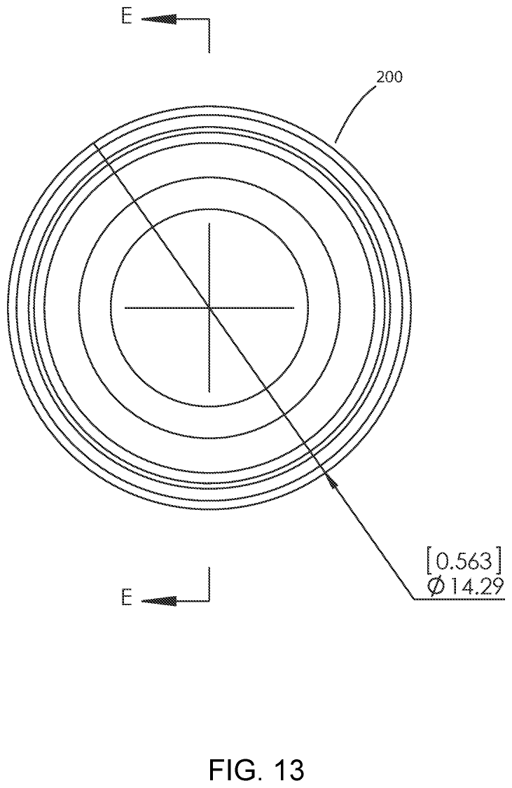

Referring to FIGS. 12-15, various views of a gasket 200 for a cap according to principles of the invention are provided. In use, the gasket 200 is seated in the cap body 100 at the top of the interior of the cap body 100. The gasket 200 is a mechanical seal which fills the space between the top interior of the cap body 100 and the free end of the service port to prevent leakage from the service port while the cap body 100 is installed. The gasket 200 is made from a material that is to some degree yielding (e.g., a resilient material such as natural rubber, silicone, nitrile butadiene rubber, neoprene rubber, epdm rubber, viton, nitrile rubber, butyl rubber) such that it is able to deform and tightly fill the space for which it is designed, including any slight irregularities. Structurally, the exemplary gasket 200 includes an annular outer periphery 205, a frustoconical projection 220 that extends from a base and is concentric with the periphery 205. A depression 210 is formed in the projection 220. The depression 210 is the negative of a spherical cap (i.e., a portion of a sphere cut by a plane). The free end of the projection 220 is a rim 215. An annular trough or furrow 230 is formed between the periphery 205 and projection 220. The top side (i.e., the side of the gasket opposite the rim 215 may be generally planar. The outer diameter (FIG. 13) of the gasket 200 is about equal to the inner diameter of the cap body 100 at the top of the interior of the cap body 100.

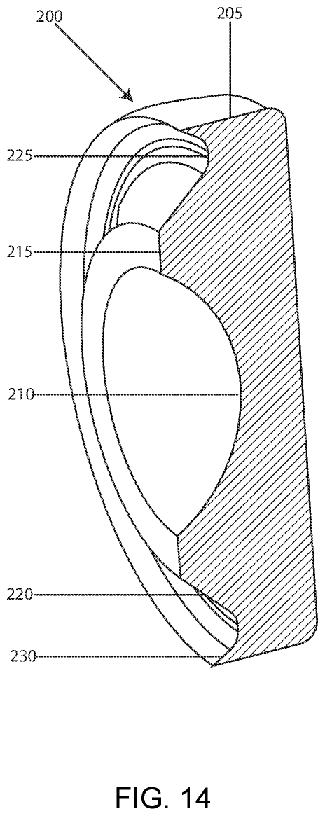

When the cap body 100 is locked onto a service port, the frustoconical plug 220 extends into the service port, the furrow 230 receives the free edge of the nipple 405 of the service port, and the periphery 205 surrounds a portion of the outer top edge of the nipple 405 of the service port. The free edge of the nipple 405 of the service port abuts the base 225 (FIG. 14) of the furrow 230. The furrow 230 is configured (i.e., sized and shaped) to provide a seal against the free edge of the nipple 405 of the service port. If the service port fails, such as by leaking pressurized fluid, the pressure will act against the depression 210, which will cause expansion of the outer diameter of the frustoconical plug 220, which will help maintain a fluid-tight seal, despite the failure. Thus, the pressure from a failure enhances integrity of sealing by the gasket 200.

In sum, the gasket is a resilient seal disposed in and occupying a top section of the generally cylindrical interior space of the middle portion of the cap body. The gasket abuts the top portion (i.e., the interior side of the top portion) of the cap body. The body of the gasket includes a generally cylindrical base, an annular outer periphery, a frustoconical projection extending from the base. The projection is concentric with the base and periphery. An annular furrow is defined between the annular outer periphery and the frustoconical projection. A depression (in the shape of a negative of a spherical cap) is formed in the free end of the frustoconical projection, concentric with the base and periphery.

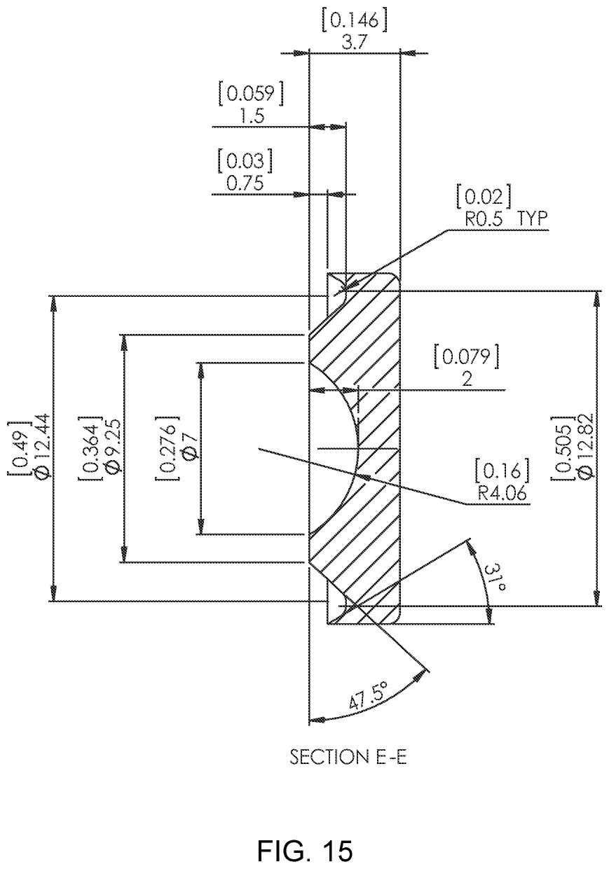

The opening at the nipple 405 of the service port is typically beveled or chamfered. In the exemplary embodiment, with reference to FIG. 15, the 47.5° angle of the frustoconical plug 220 complements the angle of the bevel, θ (FIG. 16). The two angles are complementary because they add up to 90°. This configuration ensures a flush fit between the frustoconical plug 220 and the beveled opening at the nipple 405 of the service port.

In the exemplary embodiment, with reference to FIG. 15, the elevation of the rim 215 exceeds the elevation of the periphery 205. The frustoconical projection 220 is configured (sized and shaped) to extend into and plug the opening in the nipple 405 of a service port, without extending so deep as to contact the valve stem. The maximum diameter of the frustoconical projection 220 is about equal to (e.g., equal to or slightly larger than) the inner diameter of the opening in the nipple 405 of the service port. If the maximum diameter is slightly larger (e.g., about ≤5% larger), the resiliency of the gasket material allows the frustoconical projection 220 to be urged into the opening with minimal effort.

The radius of the depression is sufficient to serve at least two functions. First, the radiused depression defines a surface upon which pressure may act evenly to expand the frustoconical projection 220. Second, the depression thins the walls that define the frustoconical projection 220. This thinning facilitates expansion under pressure.

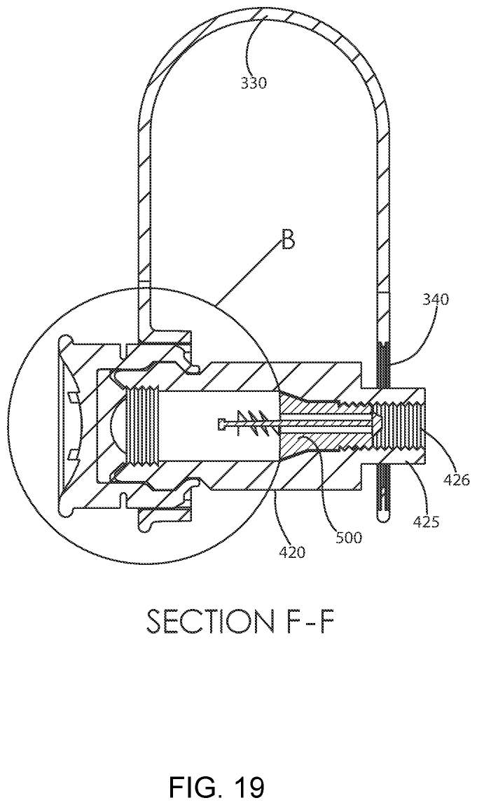

In FIG. 16, an exterior view of an exemplary service port 400 is provided. The service port 400 is a valve assembly that contains a valve core 500 (FIG. 19) and includes a radially projecting exterior annular flange 412. By way of example and not limitation, a service port may include a hollow cylindrical metal tube with a free end 405 and an attachment end 425. The free end 405 is also known as the nipple 405. The exterior surface of the tube varies in outer diameter at points along its length, as described herein. The attachment end 425, which is opposite to the free end, is configured for attachment to a container, line (e.g., tubing), equipment port or some other product. By way of example, the attachment end 425 may be internally or externally threaded or welded, brazed or otherwise coupled for attachment. The free end 405 reveals an opening 402 that extends through the service port. Internal threads 406 are provided at and or near the free end 405. Hoses and other apparatus equipped with an externally threaded port are able to mate with the internal threads 406 at the free end 405 of the service port 400.

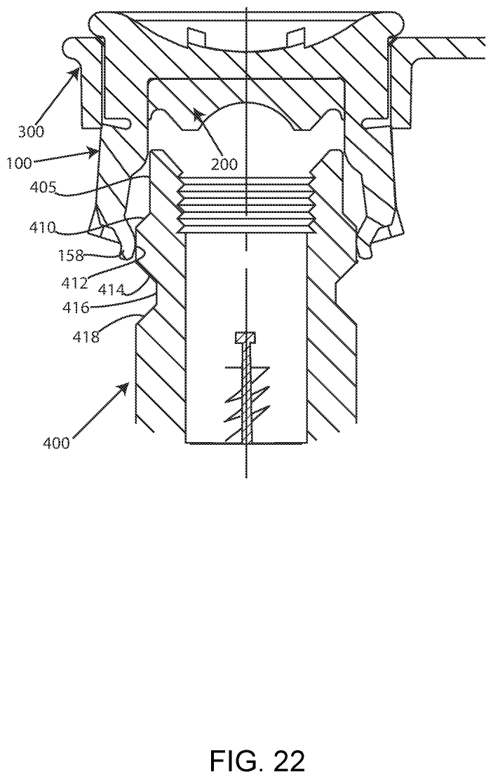

In the exemplary embodiment, the radially projecting exterior annular flange 412 includes a beveled (angled, not parallel or perpendicular to the longitudinal axis of the port 400) leading edge 410 and a beveled trailing edge 414 (FIG. 22). The outer diameter of the radially projecting exterior annular flange 412 is about equal to the inner diameter of the annular concavity 151. The annular concavity 151 is configured (i.e., positioned, sized and shaped) to receive the radially projecting exterior annular flange 412, including the beveled leading edge 410 and the beveled trailing edge 414, when the cap body 100 is installed on the service port, without causing the legs 130-135 to spread apart, and without providing appreciable excess space. In the exemplary embodiment, the fit is snug (i.e., close).

A base 420 is provided between the attachment end 425 and the radially projecting exterior annular flange 412. The base 420 may include a hexagonal section (not shown) for engagement with a wrench. In such an embodiment, if the attachment end 425 is internally or externally threaded, the hexagonal section of the base 420 may be used to tighten or loosen the service port 400. In other embodiments, the base may be cylindrical, of consistent or inconsistent outer diameter, smooth or textured (e.g., knurled) on its exterior surface. In such embodiments the base may be engaged by hand or with a pipe wrench for installation, removal and servicing.

A groove 416 is defined between the trailing edge 414 of the radially projecting exterior annular flange 412 and a leading edge 418 of the base 420. The groove 416 is configured (i.e., located, sized and shaped) to receive the bottom edge 156 and free end 158 of each leg 130-135 of the cap body 100, when the cap body 100 is installed on the service port, without causing the legs 130-135 to spread apart, and without providing appreciable excess space. In the exemplary embodiment, the fit is snug (i.e., close).

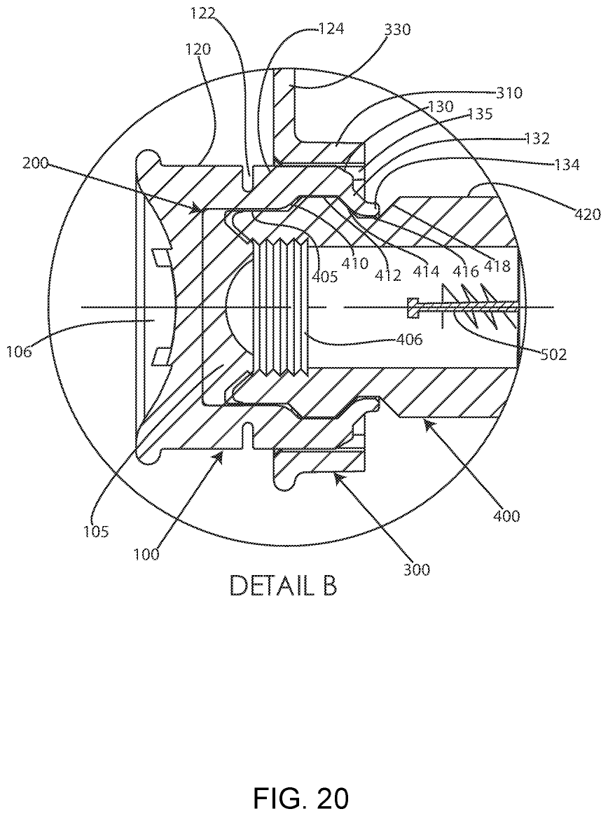

As conceptually illustrated in the section view of FIG. 19, the service port 400 includes a valve core 500. The valve core 500 is contained in the interior of the service port 400. The valve core 500 prevents flow of fluid through the interior of the service port 400 when the valve core is in a closed position. The valve core 500 permits flow of fluid through the interior of the service port 400 when the valve core is in an opened position. By way of example and not limitation, the valve core 500 may have external threads that engage internal threads 426 at the attachment end of the tube. The valve core 500 may be a pressure valve, such as a poppet valve assisted by a spring. The poppet valve may include a valve body that engages a valve seat, providing a fluid tight seal when the valve is closed. The seat may include an elastomeric seal. A valve stem 502 (FIG. 20) extends towards the free end 405 of the service port 400, but does not extend beyond the free end 405. Movement of the valve stem 502 towards the attached end, away from the free end, causes the valve body to separate from the valve seat, thereby allowing fluid to pass through the poppet valve.

Referring now to FIGS. 17-20, an exemplary cap is conceptually illustrated installed on a service port according to principles of the invention. The cap body 100 covers the portions of the service port 400 from the nipple 405 (free end) 405 to and including the groove 416. The legs 130-135 of the cap body 100 are in an undeflected position. The annular band 305 and sleeve 310 substantially surround and constrain outward movement of the legs 130-135 of the cap body 100. The collar 340 surrounds a portion of the attachment end 425 or base 420 of the service port 400. The tether 330 is bent to extend from the annular band 305 to the collar 340.

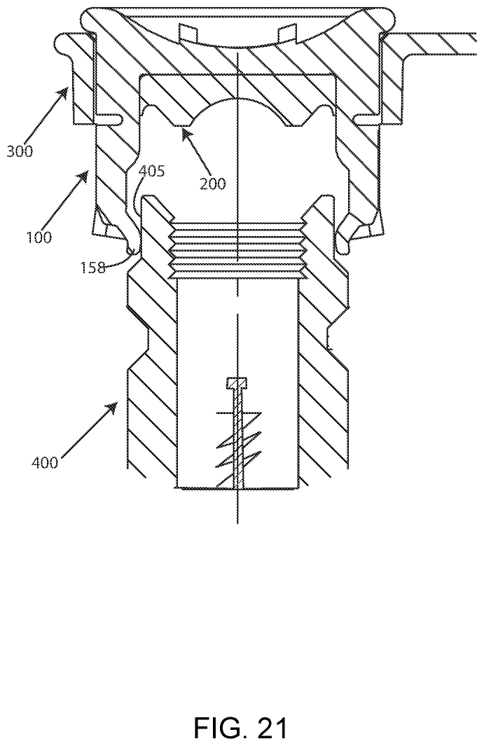

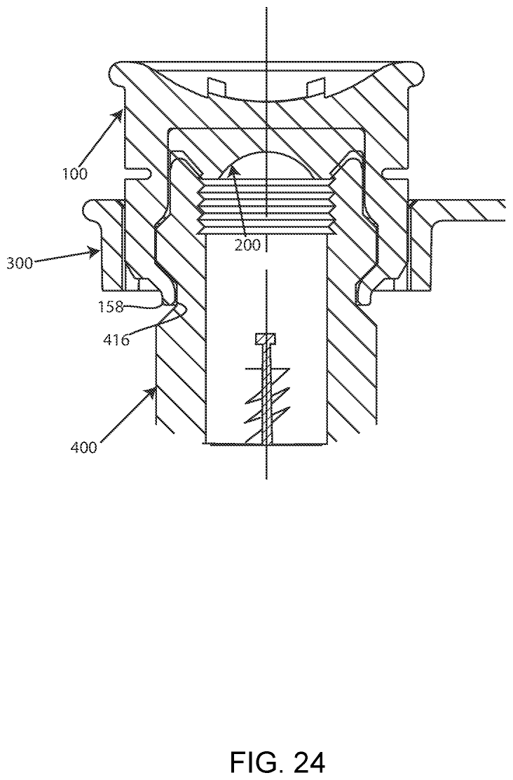

FIGS. 21-24 sequentially illustrate installation of cap according to principles of the invention. In reverse order, FIGS. 24-21 sequentially illustrate installation of cap according to principles of the invention.

In FIG. 21, the locking ring 300 is in an unlocked position, raised to the top of the cap body 100. The free end 158 of each leg 130-135 is substantially undeflected (i.e., only slightly deflected) by the outer diameter of the nipple 405, abutting the nipple 405 of the service port 400.

In FIG. 22, the cap body 100 has been advanced to the point where the free end 158 of each leg 130-135 abuts and is deflected by the radially projecting exterior annular flange 412. As the free end 158 progresses from the nipple 405 to the beveled leading edge 410, the deflection proceeds, until the free end 158 reaches the plateau of the radially projecting exterior annular flange 412. When the free end 158 reaches the plateau of the radially projecting exterior annular flange 412, as illustrated in FIG. 22, the free end 158 is at the maximum deflection caused by the radially projecting exterior annular flange 412 of the service port 400. During such deflection, the legs 131, 134 with ribs bend at the notch 122, causing the notch 122 to narrow.

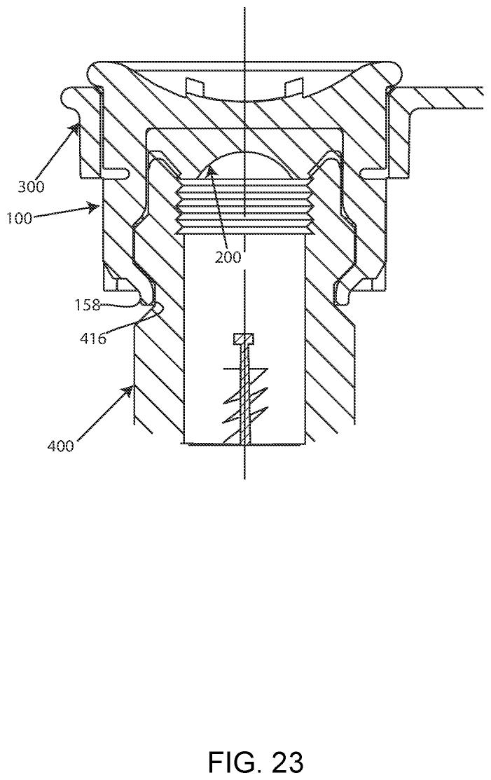

As the free end 158 progresses from the plateau of the radially projecting exterior annular flange 412 past the beveled trailing edge 414 to the groove 416, the deflection subsides, until the free end 158 of each leg 130-135 abuts the groove 416 in an undeflected position, as conceptually illustrated in FIG. 23. Concomitantly, the gasket 200 seals the service port.

The gasket 200 fills the space between the top interior of the cap body 100 and the free end of the service port to prevent leakage from the service port while the cap body 100 is installed. In this position, the frustoconical plug 220 extends into the service port, the furrow 230 receives the free edge of the nipple 405 of the service port, and the periphery 205 surrounds a portion of the outer top edge of the nipple 405 of the service port. The free edge of the nipple 405 of the service port abuts the base 225 (FIG. 14) of the furrow 230.

Then, as in FIG. 24, the locking ring 300 is moved linearly, i.e., lowered, to the locked position. In this position, the locking ring 300 prevents outward deflection of the legs 130-135. When such outward deflection is retrained, dislodging of the cap body 100 and release of the seal is prevented, absent a structural failure of the materials.

In sum, in use, the cap body covers a substantial portion of a service port. The service port includes a hollow cylindrical metal tube with a free end, an attachment end opposite the free end, and a radially projecting exterior annular flange between the free end and the attachment end. The radially projecting exterior annular flange includes a beveled leading edge and a beveled trailing edge. The hollow cylindrical metal tube contains a valve core, which prevents flow of fluid through the hollow cylindrical metal tube when the valve core is in a closed position and permits flow of fluid through the hollow cylindrical metal tube when the valve core is in an opened position. The interior annular concavity of the cap body is configured to receive and abut the radially projecting exterior annular flange of the service port, including the beveled leading edge and the beveled trailing edge of the radially projecting exterior annular flange, when the cap body is installed on the service port, without causing the legs to spread apart (i.e., deflect outwardly). An exterior annular groove is provided (defined) between the trailing edge of the radially projecting exterior annular flange and the attachment end of the hollow cylindrical metal tube of the service port. The exterior annular groove is configured to receive and abut the free end of each leg of the plurality of legs, when the cap body is installed on the service port, without causing the plurality of legs to spread apart. The frustoconical projection of the gasket extends into and seals (plugs) the free end of the hollow cylindrical metal tube of the service port, when the cap body is installed on the service port.

A cap body 100 and locking ring 300 according to principles of the invention may be comprised of any of various materials, such as plastics. In a non-limiting exemplary implementation, the cap body 100 and locking ring 300 are comprised of a polyvinyl chloride (PVC), nylon, polysulfone, polyethylene, polypropylene, polystyrene, acrylics, cellulosics, acrylonitrile-butadiene-styrene (ABS) terpolymers, urethanes, thermo-plastic resins, thermo-plastic elastomers (TPE), acetal resins, polyamides, polycarbonates and/or polyesters. Plasticizers or dispersants are may be incorporated in the plastic to improve flexibility of the material. Other suitable plastic compositions are known to those familiar with the art and may also be used in accordance with the present invention. Preferably the chosen material is relatively inexpensive, produces a durable and strong product, is easy to use in manufacturing operations and results in an aesthetically acceptable product.

The cap body 100 and locking ring 300 may optionally be formulated to change color when it reaches a predetermined or higher temperature. This can be accomplished by mixing a thermochromic additive (e.g., thermochromic pigment) to the base material in an amount that is sufficient to achieve a desired color changing range. As an example, a mixture of approximately 5% to 30% (pbw) of Matsui International Co., Inc.'s Chromicolor concentrate may be introduced to the base material, to provide a plastic structure that visibly changes color at a determined elevated temperature. The elevated temperature may correspond to a temperature having functional significance to the pressurized fluid. For example, the temperature may indicate a temperature above or below which the pressurized fluid should not be maintained.

Alternatively, a photochromic additive may be added to the base material in an amount that is effective to achieve a desired color change when the cap body 100 and locking ring 300 is exposed to certain lighting conditions. As an example, a mixture of approximately 5% to 35% (pbw) of Matsui International Co., Inc.'s Photopia additive may be introduced to the base material, to provide a plastic structure that visibly changes color in the presence of ultraviolet light. Such a composition may render the cap body and locking ring 300 easy to find in a crowded engine compartment illuminated by an ultraviolet light.

As another alternative, phosphorescent polymer additives, such as aluminate based phosphors, may be added to adsorb light energy and continue to release that energy as visible light after the energy source is removed. Advantageously, such an embodiment provides a cap body 100 and locking ring 300 that is easy to locate in darkened conditions.

The cap body 100 and locking ring 300 may be produced using any suitable manufacturing techniques known in the art for the chosen material, such as (for example) injection, compression, structural foam, blow, or transfer molding; polyurethane foam processing techniques; vacuum forming; and casting. Preferably, the manufacturing technique is suitable for mass production at relatively low cost per unit, and results in an aesthetically acceptable product with a consistent acceptable quality.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A cap assembly for sealing a service port, the service port being a port containing a valve core for controlling the flow of a pressurized fluid, the cap assembly comprising a cap body, a locking ring, and a gasket;
the cap body comprising:
a top portion, the top portion providing a cover;
a middle portion extending from the top portion, the middle portion being a tubular portion defining a generally cylindrical interior space;
a bottom portion extending from the middle portion, the bottom portion including an interior annular concavity, the interior annular concavity including a pitched leading edge, a cylindrical central portion and a pitched trailing edge, the pitched leading edge extending from the middle portion to the cylindrical central portion, and the pitched trailing edge extending from the cylindrical central portion to a free end;
a plurality of spaced apart longitudinal slots extending from the middle portion to the bottom portion, the plurality of spaced apart longitudinal slots including at least 4 spaced apart longitudinal slots, and adjacent slots of the plurality of spaced apart longitudinal slots defining a leg therebetween, and the plurality of spaced apart longitudinal slots defining a plurality of legs, and each leg of the plurality of legs being capable of outward deflection from an undeflected position when a deflecting force acts thereon, and resuming an undeflected position when the deflecting force ceases acting thereon;
the locking ring comprising an annular band, the annular band surrounding a portion of the cap body and being movable longitudinally between a locked position and an unlocked position, and in the unlocked position the annular band surrounding a portion of the middle portion, and in the locked position, the annular band surrounding a portion of the bottom portion and limiting outward deflection of each leg from the undeflected position;
the gasket comprising a resilient seal, the gasket being disposed in and occupying a top section of the generally cylindrical interior space of the middle portion, the gasket abutting the top portion.

2. The cap assembly for sealing a service port as in claim 1, the plurality of spaced apart longitudinal slots comprising at least six spaced apart longitudinal slots and defining at least six spaced apart legs.

3. The cap assembly for sealing a service port as in claim 2, the plurality of spaced apart longitudinal slots being evenly spaced apart.

4. The cap assembly for sealing a service port as in claim 1, each leg including a free end, each free end including a beveled inner edge.

5. The cap assembly for sealing a service port as in claim 1:
the cap body further comprising an exterior surface and at least one rib, each rib of the at least one rib:
having a rib width,
extending outwardly from the exterior surface of the cap body,
extending longitudinally from the top portion to the bottom portion, and
including an upper segment, a lower segment and a notched segment between the upper segment and lower segment, the notched segment facilitating bending; and
the annular band including an interior band surface and a slot in the interior band surface for each rib, each slot having a slot width that is at least equal to the rib width and each slot being aligned with one of the at least one rib.

6. The cap assembly for sealing a service port as in claim 1:
the cap body further comprising a plurality of shims, each shim of the plurality of shims:
being an outward protrusion,
being located on one of the plurality of legs at the bottom portion of the cap body, and
occupying space between the annular band and the leg when the locking ring is in a locked position.

7. The cap assembly for sealing a service port as in claim 1, the cap body including a first wall thickness at the middle portion, and a second wall thickness at the bottom portion, the first wall thickness being less than the second wall thickness.

8. The cap assembly for sealing a service port as in claim 1, the top portion defining a radially extending flange.

9. The cap assembly for sealing a service port as in claim 1, the cap body being integrally formed by injection molding a thermoplastic, and the locking ring being integrally formed by injection molding a thermoplastic.

10. The cap assembly for sealing a service port as in claim 1, the gasket further comprising an annular outer periphery, a frustoconical projection that is concentric with the annular outer periphery, and an annular furrow between the annular outer periphery and the frustoconical projection.

11. The cap assembly for sealing a service port as in claim 10, the frustoconical projection including a free end, and the gasket further comprising a depression in the free end of the frustoconical projection.

12. The cap assembly for sealing a service port as in claim 11, the depression and frustoconical projection being concentric.

13. The cap assembly for sealing a service port as in claim 12, the depression being a negative of spherical cap.

14. The cap assembly for sealing a service port as in claim 5, the locking ring further comprising a sleeve extending from the annular band, the sleeve and annular band being concentric and having equal inner diameters, the sleeve having an interior sleeve surface.

15. The cap assembly for sealing a service port as in claim 14, the slot in the interior band surface for each rib extending continuously along the interior band surface of the annular band and along the interior sleeve surface of the sleeve.

16. The cap assembly for sealing a service port as in claim 14,
the cap body further comprising a plurality of shims, each shim of the plurality of shims:
being an outward protrusion,
being located on one of the plurality of legs at the bottom portion of the cap body, and
occupying space between the annular band and the leg when the locking ring is in a locked position; and
a peripheral protrusion extending inwardly from the interior sleeve surface of the sleeve, the peripheral protrusion abutting one shim of the plurality of shims when the locking ring is in a locked position.

17. The cap assembly for sealing a service port as in claim 1, the locking ring further comprising a collar, the collar including a central aperture, and a tether coupling the annular band to the collar, the tether being flexible.

18. The cap assembly for sealing a service port as in claim 1, further comprising:
a service port comprising:
a hollow cylindrical metal tube with a free end, an attachment end opposite the free end, a radially projecting exterior annular flange between the free end and the attachment end, the radially projecting exterior annular flange including a beveled leading edge and a beveled trailing edge, a valve core contained in the hollow cylindrical metal tube, the valve core preventing flow of fluid through the hollow cylindrical metal tube when the valve core is in a closed position, the valve core permitting flow of fluid through the hollow cylindrical metal tube when the valve core is in an opened position; and
the interior annular concavity being configured to receive and abut the radially projecting exterior annular flange, including the beveled leading edge and the beveled trailing edge, when the cap body is installed on the service port, without causing the plurality of legs to deflect.

19. The cap assembly for sealing a service port as in claim 18, each leg of the plurality of legs including a free end, and the cap assembly further comprising:
an exterior annular groove between the trailing edge of the radially projecting exterior annular flange and the attachment end of the hollow cylindrical metal tube of the service port, and the exterior annular groove being configured to receive and abut the free end of each leg of the plurality of legs, when the cap body is installed on the service port, without causing the plurality of legs to deflect.

20. The cap assembly for sealing a service port as in claim 12, further comprising:
a service port comprising:
a hollow cylindrical metal tube with a free end, an attachment end opposite the free end, a radially projecting exterior annular flange between the free end and the attachment end, the radially projecting exterior annular flange including a beveled leading edge and a beveled trailing edge, and an exterior annular groove between the trailing edge of the radially projecting exterior annular flange and the attachment end of the hollow cylindrical metal tube of the service port, and a valve core contained in the hollow cylindrical metal tube, the valve core preventing flow of fluid through the hollow cylindrical metal tube when the valve core is in a closed position, the valve core permitting flow of fluid through the hollow cylindrical metal tube when the valve core is in an opened position; and
the interior annular concavity being configured to receive and abut the radially projecting exterior annular flange, including the beveled leading edge and the beveled trailing edge, when the cap body is installed on the service port, without causing the plurality of legs to deflect; and
the exterior annular groove being configured to receive and abut the free end of each leg of the plurality of legs, when the cap body is installed on the service port, without causing the plurality of legs to deflect; and
the frustoconical projection of the gasket extending into and plugging the free end of the hollow cylindrical metal tube of the service port.
